(19) United States
(12) Patent Application Publication
(10) Pub. No.: US 2025/0215360 A1
(43) Pub. Date: Jul. 3, 2025

(54) PERFUME-CONTAINING PARTICLES AND THE MAKING METHOD

(71) Applicant: The Procter & Gamble Company, Cincinnati, OH (US)

(72) Inventors: Qiuyang HE, Beijing (CN); Pu ZHAO, Beijing (CN); Rui SHEN, Beijing (CN); Carola BARRERA, West Chester, OH (US); Mark Robert SIVIK, Mason, OH (US)

(21) Appl. No.: 18/983,807

(22) Filed: Dec. 17, 2024

(30) Foreign Application Priority Data
Dec. 27, 2023 (WO) PCT/CN2023/142385

(51) Int. Cl. C11D 3/50; C11D 3/04; C11D 3/37; C11D 11/00; C11D 17/00

(52) U.S. Cl. CPC C11D 3/505; C11D 3/046; C11D 3/3707; C11D 11/0082; C11D 17/0039

(57) ABSTRACT

A laundry additive composition including a plurality of perfume-containing particles. Each of said perfume-containing particles includes: a perfume ingredient; polyethylene glycol; and an inorganic salt carrier which is selected from the group consisting of magnesium sulfate, magnesium chloride, and the combination thereof. Each of said perfume-containing particles has a mass of from 1 mg to 1 g and a maximum dimension of from 3 mm to 10 mm.

### TECHNICAL FIELD

The present disclosure is related to perfumed particles containing magnesium inorganic salt and the method of making the same.

### BACKGROUND

Scent is recognized to be a source of pleasure to consumers when they do their laundry. Consumers may associate certain scents with performance of the laundry products and as an indicator of quality of the laundry products. Laundry products that provide a pleasant or enhanced scent experience to the consumer when she dispenses the laundry product, transfers a load of wet laundry from the washer to the dryer or to a drying rack or line, or when she wears the clothing meet this consumer need.

Correspondingly, perfume-containing particles are becoming increasingly popular as a laundry scent additive. The perfume-containing particles can be used to impart new scent to, or enhance existing scent in, the articles being washed.

Most of such perfume-containing particles contains one or more perfume ingredients mixed carrier materials. The perfume ingredients may be selected from the group consisting of free perfumes, encapsulated perfumes (also called perfume microcapsule, PMC), and combinations thereof. The carrier materials may be selected from the group consisting of: polymers (e.g., polyethylene glycol, ethylene oxide/propylene oxide block copolymers, polyvinyl alcohol, polyvinyl acetate, and derivatives thereof), proteins (e.g., gelatin, albumin, casein, and the like), sugars (e.g., dextrose, fructose, galactose, glucose, isoglucose, sucrose, and the like), water-soluble or water-dispersible fillers (e.g., zeolite, silica, clay, and the like), and combinations thereof. Some perfume-containing particles contain only one type of carrier material, while others may contain a mixture of two or more different carrier materials.

There is a continuous need for perfume-containing particles providing long-lasting pleasant scent experience to the consumer, e.g., after drying or even after storage. One approach is to increase the level of perfume microcapsules (PMC), which will release perfume slowly compared to free perfume. However, it is discovered that perfumed particles containing too much PMC would cause hardness issue, e.g., less hardness may cause easy to break. Meanwhile, perfumed particles containing too much PMC would have challenge on dissolution/solubility. There is therefore a need to provide perfumed particles containing high level of PMC for providing pleasant consumer experience and satisfaction, and at the same time exhibiting desired hardness and desired dissolution.

### SUMMARY

The applicants surprisingly discover perfumed particles containing high level of perfumes (especially encapsuled perfumes) which could provide long-lasting pleasant scent experience, by introducing mixture filler carrier of polyethylene glycol with certain type of alkaline earth metal inorganic salt carrier which is selected from the group consisting of magnesium sulfate, magnesium chloride, and the combination thereof. Surprisingly and unexpectedly, certain amount of the inorganic salt carrier having specific particle size provide not only good hardness but also desired solubility to the perfumed particle.

In one aspect, the present disclosure is related to a composition comprising a plurality of perfume-containing particles, wherein each of said perfume-containing particles comprises a perfume ingredient; polyethylene glycol; and an alkaline earth metal inorganic salt which is selected from the group consisting of magnesium sulfate, magnesium chloride, and the combination thereof. Each of said perfume-containing particles has a mass of from 1 mg to 1 g and a maximum dimension of from 3 mm to 10 mm. preferably, each of said particles has a density more than 1 g/cm³, preferably more than 1.05 g/cm³.

Preferably, the perfume ingredient in the composition of the present disclosure comprises an encapsulated perfume, which is preferably present in friable perfume microcapsules, and wherein more preferably the friable perfume microcapsules are present in an amount ranging from more than 2% to 30%, preferably from more than 5% to 25%, more preferably from more than 5% to 20%, still more preferably from more than 8% to 16%, by weight of each perfume-containing particle.

Preferably, the perfume ingredient in the composition of the present disclosure comprises one or more free perfumes, which are preferably present in an amount ranging from 0.1% to 20%, preferably 0.5% to 15%, more preferably from 1% to 10%, by weight of each perfume-containing particle.

Preferably, the polyethylene glycol in the composition of the present disclosure has a weight average molecular weight (Mw) from 2,000 to 30,000 Daltons, preferably from 3,000 to 20,000 Daltons, more preferably from 4,000 to 15,000 Daltons; wherein the polyethylene glycol is present in each perfume-containing particle in an amount ranging from 5% to 90%, preferably from 40% to 85%, more preferably from 50% to 80%, by weight of each perfume-containing particle.

Preferably, each of said perfume-containing particles of the present disclosure comprises from 1% to 40% of the alkaline earth metal inorganic salt, preferably from 2% to 35%, and more preferably from 4% to 32%, by weight of each perfume-containing particle. Preferably, from 80 wt % to 100 wt % of the alkaline earth metal inorganic salt are particles characterized by a particle size less than 600 microns, preferably by a particle size of from 50 microns to 600 microns, more preferably by a particle size of from 50 microns to 420 microns.

Preferably, each of the perfume-containing particles further comprises one or more other ingredients selected from the group consisting of colorants, solvents, and combinations thereof, and wherein said one or more other ingredients are present in an amount ranging from 0.01% to 10%, preferably from 0.02% to 8%, more preferably from 0.1% to 5%, by weight of each perfume-containing particle.

Preferably, each of said particles has a hemispherical shape, a compressed hemispherical shape, or a hemi-ellipsoidal shape. Preferably, each of said particles has a mass from 5 mg to 1 g, preferably from 10 mg to 500 mg, and/or has a maximum dimension of from 4 mm to 9 mm.

Another aspect of the present disclosure relates to a method of making perfume-containing particles, comprising the steps of:

a) forming a viscous slurry by mixing a perfume ingredient, molten polyethylene glycol, inorganic salt filler particles and optionally one or more other ingredients, wherein said inorganic salt filler particles can pass through a sieve characterized by a mesh size of 600 um; and
b) forming perfume-containing particles from the viscous slurry, wherein each of the perfume-containing particles so formed has a mass of from 1 mg to 1 g and a maximum dimension of from 3 mm to 10 mm;

wherein said inorganic salt filler particles comprise a filler material selected from the group consisting of magnesium sulfate, magnesium chloride, and the combination thereof.

Preferably, said inorganic salt filler particles can pass through a sieve characterized by a mesh size of 400 um, more preferably can pass through a sieve characterized by a mesh size of 150 um.

Each of the above-mentioned perfume-containing particles may comprise one or more perfume ingredients selected from the group consisting of free perfumes, encapsulated perfumes, and combinations thereof. In a specific embodiment, the perfume-containing particles contain one or more free perfumes, which are preferably present in an amount ranging from about 0.1% to about 25%, alternatively from about 0.2% to about 20%, preferably from about 0.5% to about 15%, more preferably from about 1% to about 10%, by total weight of each perfume-containing particle. Further, the perfume-containing particles contain, either alone or in combination with the free perfumes, an encapsulated perfume. Preferably, the encapsulated perfume is present in friable perfume microcapsules, while the friable perfume microcapsules are preferably present in an amount ranging from more than 2% to 30%, preferably from more than 5% to 25%, more preferably from more than 5% to 20%, by weight of each perfume-containing particle. In an exemplary embodiment, the perfume-containing particles contain from 8% to 16% of friable perfume microcapsules, by weight of the each perfume-containing particle.

Optionally, the perfume-containing particles of the present disclosure may further comprise one or more other ingredients selected from the group consisting of colorants, solvents, and combinations thereof. In some examples, said one or more ingredients are present in an amount ranging from 0.01% to 10%, preferably from 0.02% to 8%, more preferably from 0.1% to 5%, by total weight of each perfume-containing particle.

These and other aspects of the present disclosure will become more apparent upon reading the following detailed description.

### DETAILED DESCRIPTION

Features and benefits of the various embodiments of the present disclosure will become apparent from the following description, which includes examples of specific embodiments intended to give a broad representation. Various modifications will be apparent to those skilled in the art from this description. The scope of the present disclosure is not intended to be limited to the particular forms disclosed and covers all modifications, equivalents, and alternatives falling within the spirit and scope of the present disclosure as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, terms such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

The term “perfume-containing particle” or “perfumed particle” refers to a particle comprising one or more perfume ingredients, such as free perfumes, pro-perfumes, encapsulated perfumes (including perfume microcapsules), and the like. Preferably, such perfume-containing particles contain perfumes encapsulated in perfume microcapsules, especially friable perfume microcapsules.

The term “aspect ratio” refers to the ratio of the longest dimension of the perfume-containing particles over its shortest dimension. For example, when such perfume-containing particles have a hemispherical, compressed hemispherical or hemi-ellipsoidal shape, the aspect ratio is the ratio between the based (longest) diameter of the perfume-containing particles over its height.

The term “consisting essentially of” means that the composition contains less than about 1%, preferably less than about 0.5%, of ingredients other than those listed.

Further, the term “substantially free of” or “substantially free from” means that the indicated material is present in the amount of from 0 wt % to about 1 wt %, preferably from 0 wt % to about 0.5 wt %, more preferably from 0 wt % to about 0.2 wt %. The term “essentially free of” means that the indicated material is present in the amount of from 0 wt % to about 0.1 wt %, preferably from 0 wt % to about 0.01 wt %, more preferably it is not present at analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

### Perfume-Containing Particles

The present disclosure is related to perfume-containing particles and the method of making the same. The perfume-containing particles of the present disclosure may each have specific shapes, sizes, mass, and/or density. The perfume-containing particles of the present disclosure may have a longest dimension of from about 3 mm to about 10 mm, preferably from about 4 mm to about 9 mm, more preferably from about 5 mm to about 8 mm. Preferably, each of such perfume-containing particles may have an aspect ratio of no more than about 5, e.g., from about 1 to about 5, preferably from about 1.5 to about 4, more preferably from about 2 to about 4.

The perfume-containing particles of the present disclosure may have any shape selected from the group consisting of spherical, hemispherical, compressed hemispherical, hemi-ellipsoidal, cylindrical, disc, circular, lentil-shaped, oblong, cubical, rectangular, star-shaped, flower-shaped, and any combinations thereof. Lentil-shaped refers to the shape of a lentil bean. Compressed hemispherical refers to a shape corresponding to a hemisphere that is at least partially flattened such that the curvature of the curved surface is less, on average, than the curvature of a hemisphere having the same radius. A compressed hemispherical particle can have an aspect ratio (i.e., the ratio of its base diameter over its height that is orthogonal to the base) of from about 2.0 to about 5, alternatively from about 2.1 to about 4.5, alternatively from about 2.2 to about 4. Oblong-shaped particle refers to a particle having a maximum dimension and a secondary dimension orthogonal to the maximum dimension, wherein the ratio of maximum dimension to the secondary dimension is greater than about 1.2, preferably greater than about 1.5, more preferably greater than about 2. A hemi-ellipsoidal particle refers to a shape corresponding to a half of an ellipsoidal or oblong shape, where the flattened base has major axis and minor axis, and the hemi-ellipsoidal particle can have an aspect ratio (i.e., the ratio of its major axis over its height that is orthogonal to the flattened base) of from about 2 to about 5, alternatively from about 2.1 to about 4.5, alternatively from about 2.2 to about 4.

Preferably, the perfume-containing particles of the present disclosure have a hemispherical shape, a compressed hemispherical shape or a hemi-ellipsoidal shape.

An individual perfume-containing particle may have a volume from about 0.003 cm3 to about 0.15 cm3, preferably from about 0.005 cm3 to about 0.12 cm3. Further, individual perfume-containing particles of the present disclosure can each have a mass of from about 0.1 mg to about 5 g, preferably from about 1 mg to about 1 g, more preferably from about 5 mg to about 500 mg, still more preferably from about 10 mg to about 250 mg, still more preferably from about 15 mg to about 125 mg, with alternative combinations thereof and any whole numbers or ranges of whole numbers of mg within any of the aforementioned ranges.

In a preferred embodiment, the perfume-containing particles of the present disclosure have a density higher than water, i.e., more than 1.0 g/cm³. For example, such perfume-containing particles may have a density ranging from about 1.0 g/cm³ to about 1.4 g/cm³, preferably from about 1.05 g/cm³ to about 1.25 g/cm³.

In alternative embodiment of the present disclosure, perfume-containing particles of the present disclosure may have a density lower than water, so that they can float on water, for example, a density from 0.7 g/cm³ to 0.95 g/cm³, alternatively from 0.8 g/cm³ to 0.9 g/cm³.

The perfume-containing particles of the present disclosure comprise: a perfume ingredient; polyethylene glycol; inorganic carrier characterized by a specific particle size distribution; and optionally one or more adjunct ingredients, as described in detail hereinafter. Preferably, the inorganic salt carrier is a filler particle selected from the group consisting of magnesium sulfate, magnesium chloride, and the combination thereof.

### Perfume Ingredients

The perfume-containing particles of the present disclosure may comprise one or more perfume ingredients selected from the group consisting of free perfumes, encapsulated perfumes, and combinations thereof.

In a specific embodiment, the perfume-containing particles contain one or more free perfumes, which are preferably present in an amount ranging from about 0.1% to about 25%, alternatively from about 0.2% to about 20%, preferably from about 0.5% to about 15%, more preferably from about 1% to about 10%, by total weight of each perfume-containing particle.

Further, the perfume-containing particles contain, either alone or in combination with the free perfumes, an encapsulated perfume. Preferably, the perfume-containing particles comprise perfume oil encapsulated in perfume microcapsules (PMCs), which are preferably friable (verses, for example, moisture activated PMCs) but can also be moisture activated. For purposes of the present disclosure, the term “perfume microcapsules” or “PMC” describes both perfume microcapsules and perfume nanocapsules. Preferably, PMCs are preferably present in an amount ranging from more than 2% to 30%, preferably from more than 5% to 25%, more preferably from more than 5% to 20%, by weight of each perfume-containing particle. For example, the perfume-containing particles may contain about 3%, or about 4%, or about 5%, or about 6%, or about 8%, or about 9%, or about 10%, or about 11%, or about 12%, or about 13%, or about 14%, or about 15%, or about 16%, or about 17%, or about 18%, or about 19%, or about 20%, and any whole numbers or ranges of whole numbers within any of the aforementioned ranges.

In another embodiment, each of the perfume-containing particles comprises both free perfumes and encapsulated perfumes (preferably in form of perfume microcapsules, and more preferably in form of friable perfume microcapsules), e.g., at a weight ratio ranging from about 1:20 to about 5:1, alternatively from about 1:10 to about 2:1, further alternatively from about 1:8 to about 1:1.

In one embodiment, the PMCs comprise melamine/formaldehyde shells, which are commercially available from Appleton, Quest International, International Flavor & Fragrances, or other suitable sources. In a preferred embodiment, the shells of the PMCs are coated with polymer to enhance the ability of the PMCs to adhere to fabric.

In yet still another embodiment, the perfume-containing particles may comprise a formaldehyde scavenger. In yet still another embodiment, the scent of the perfume-containing particles is coordinated with scent(s) of other fabric care products (e.g., laundry detergent). This way, consumers who like APRIL FRESH scent, may use a packaged composition containing a plurality of perfume-containing particles having an APRIL FRESH scent, thereby coordinating the scent experience of washing their laundry with their scent experience from using APRIL FRESH. The perfume-containing particles of the present disclosure may be sold as a product array (with laundry detergent) having coordinated scents.

### Polyethylene Glycol (PEG)

The perfume-containing particles of the present disclosure comprise polyethylene glycol (PEG) as a first carrier. PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

Preferably, each of the perfume-containing particles comprises from about 5 wt % to about 90 wt %, preferably from about 40 wt % to about 85 wt %, more preferably from about 41 wt % to about 80 wt % of PEG, and more preferably such PEG is characterized by a weight average molecular weight (Mw) ranging from about 2,000 to about 30,000 Daltons, preferably from about 3,000 to about 20,000 Daltons, more preferably from about 4,000 to about 15,000 Daltons. Suitable PEGs include homopolymers commercially available from BASF under the tradenames of Pluriol® E 8000.

A particularly preferred PEG within the meaning of the present disclosure is an ethylene oxide-propylene oxide-ethylene oxide (EOx₁POyEOx₂) triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOx₁POyEOx₂) triblock copolymer has a molecular weight of from about 2000 to about 30,000 Daltons, preferably from about 3000 to about 20,000 Daltons, more preferably from about 4000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂) triblock copolymer improve cleaning.

Suitable ethylene oxide-propylene oxide-ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

### Alkali Earth Metal Inorganic Salt Filler

In addition to the above-described perfume ingredients and PEG, the perfume-containing particles of the present disclosure further comprise a water-soluble inorganic salt filler material in a particulate form, as a second carrier.

The filler material can be or comprise a water-soluble inorganic alkaline earth metal salt. Specifically, the filler material can be or comprise a water-soluble material selected from the group consisting of magnesium sulfate, magnesium chloride, and a combination thereof.

Among all the alkali metal salts and alkali earth metal salts, the applicant surprisingly discover that specific salts such as magnesium sulfate, magnesium chloride, can provide a stable perfumed particles containing a high level of PMCs. In a preferred embodiment, the inorganic salt filler material is magnesium sulfate. In another preferred embodiment, the inorganic salt filler material is magnesium chloride.

Preferably, each of the perfume-containing particles comprises from about 1 wt % to about 40 wt %, preferably from about 2 wt % to about 35 wt %, more preferably from about 4 wt % to about 32 wt % of the inorganic salt, by weight of each perfume-containing particle.

Preferably, from 80 wt % to 100 wt % of said inorganic salt filler material present in the perfume-containing particles are characterized by a particle size less than 600 microns, preferably from 50 microns to 600 microns, more preferably from 50 microns to 500 microns.

The alkaline earth metal inorganic salt filler material is present in the perfume-containing particles in a particulate form, i.e., as discrete particles having a specific particle size distribution. Without being bound by any theory, said alkaline earth metal inorganic salt is anhydrous salt, when is introduced into the melt, it may form salt hydrate and dispersed in the melt, thus to make the beads stable even with high PMCs (in which water is introduced).

In some examples, from about 80 wt % to 100 wt %, preferably from about 85 wt % to 100 wt %, more preferably from about 90 wt % to 100 wt %, still more preferably from about 95 wt % to 100 wt %, still more preferably from about 98 wt % to 100 wt %, and most preferably from about 99 wt % to 100 wt % of such discrete particles have a particle size of from about 400 microns to about 600 microns. Preferably, from about 80 wt % to 100 wt % of such discrete particles have a particle size of from about 400 microns to about 550 microns.

In some alternative and preferred examples, from about 80 wt % to 100 wt %, preferably from about 85 wt % to 100 wt %, more preferably from about 90 wt % to 100 wt %, still more preferably from about 95 wt % to 100 wt %, still more preferably from about 98 wt % to 100 wt %, and most preferably from about 99 wt % to 100 wt % of such discrete particles have a particle size of no more than 150 microns. Preferably, from about 80 wt % to 100 wt % of such discrete particles have a particle size of from about 5 microns to about 150 microns, preferably from about 10 microns to about 125 microns, more preferably from about 10 microns to about 105 microns, most preferably from about 10 microns to about 90 microns.

The filler material, other than magnesium sulfate, magnesium chloride, may also include additional water-dispersible material selected from the group consisting of other inorganic alkali metal salt, organic alkali metal salt, inorganic alkaline earth metal salt, organic alkaline earth metal salt, starch (including modified starch), cellulose (including modified cellulose) zeolite, silica, clay, and combinations thereof. For example, in an embodiment, the perfume-containing particles of the present disclosure may comprise magnetic sulfate as well as sodium sulfate.

### Optional/Adjunct Ingredients

The perfume-containing particles of the present disclosure may optionally comprise one or more optional/adjunct ingredients, including colorants, solvents, germ killing materials, anti-mite materials, dye transfer inhibitors, and combinations thereof, in an amount ranging from about 0.01% to 10%, preferably from 0.02% to 8%, more preferably from 0.1% to 5%.

The colorants may impart to the perfume-containing particles a color selected from the group consisting of blue, green, yellow, orange, pink, red, purple, grey, and the like. The colorants may be selected from the group consisting of dyes, pigments, and combinations thereof. Preferably, the colorants include at least one dye selected from those typically used in laundry detergent. Examples of suitable dyes include, but are not limited to, LIQUITINT BLUE BL, LIQUITINT PINK AM, AQUA AS CYAN 15, and VIOLET FL, available from Milliken Chemical. If a dye is employed, the perfume-containing particles may comprise less than about 0.1%, alternatively about 0.001% to about 0.1%, alternatively about 0.01% to about 0.02%, alternatively combinations thereof of such dye by weight of the particles.

The perfume-containing particles of the present disclosure may be substantially free of laundry active. To reduce costs and avoid formulation capability issues, one aspect of the present disclosure may include perfume-containing particles that are essentially free or completely free of laundry actives. In one embodiment, each of the perfume-containing particles comprises less than about 3%, alternatively less than about 2%, alternatively less than about 1%, alternatively less than about 0.1% by weight of the perfume-containing particles, of laundry. Laundry actives may include detergent surfactants, detergent builders, bleaching agents, enzymes, mixtures thereof, and the like. It is particularly preferred that the perfume particles of the present disclosure are substantially free of or essentially free of surfactants, because the presence of such surfactants may speed up dissolution of the perfume particles in water, which is undesirable in the context of the present disclosure. It is appreciated that a non-detersive level of surfactant may be used to help solubilize perfume contained in the composition. More preferably, the perfume particles of the present disclosure are substantially free of or essentially free of any detersive actives.

Depending on the application, the perfume-containing particles of the present disclosure may comprise a solvent selected from the group consisting of glycerin, polypropylene glycol, isopropyl myristate, dipropylene glycol, 1,2-propanediol, and PEG having a weight average molecular weight less than 2,000, and mixtures thereof.

The perfume-containing particles can further comprise an antioxidant. The antioxidant can help to promote stability of the color and or odor of the particles over time between production and use. The perfume-containing particles can comprise between about 0.001% to about 2%, preferably between 0.01% to about 1%, more preferably between about 0.05% to about 0.5% by weight of such antioxidant. The antioxidant can be butylated hydroxytoluene.

### Method of Making Perfume-Containing Particles

The perfume-containing particles of the present disclosure may be formed by those methods known in the art for making pastilles. The perfume-containing particles of the present disclosure may be prepared in either a batch mode or a continuous mode. In a batch mode, molten PEG is loaded into a mixing vessel having temperature control. Perfume ingredients (e.g., free perfumes and/or PMCs), the water-soluble inorganic salt filler particles (e.g., magnesium chloride particles, magnesium sulfate particles, and the like), and the optional ingredients (such as dyes, pigments, solvents, and the like) are then added and mixed with the molten PEG until homogeneous. In a continuous mode, molten PEG is mixed with the above-described perfume ingredients, filler particles, and optional ingredients in an in-line mixer such as a static mixer or a high shear mixer and the resulting homogeneous mixture is then used for pastillation. Perfume ingredients, filler particles and optional ingredients can be added to the molten PEG in any order or simultaneously at a step prior to pastillation.

The perfume-containing particles may be manufactured by a pastillation process. A desired formulation containing the above-described molten PEG, perfume ingredients, filler particles, and optional ingredients is provided as a viscous slurry. The viscous slurry can be provided at a processing temperature less than about 20 degrees Celsius above the onset of solidification temperature of the PEG material as determined by differential scanning calorimetry. In one embodiment, the PMCs can be added as a slurry to the molten PEG and free perfume to form the viscous slurry. The PMCs can also be added as a powder to the molten PEG and free perfume to form the viscous slurry.

In a specifically preferred embodiment of the present disclosure, gas or gas-generating ingredients can be added into the viscous slurry to form an aerated viscous slurry.

The viscous slurry, either aerated or unaerated, can then be formed into perfume-containing particles (especially in form of pastilles) by a ROTOFORMER available from Sandvik Materials Technology. Specifically, the viscous slurry can be distributed through a feed pipe to a stator. A cylinder is provided for rotating about the stator along a longitudinal axis L of such cylinder, wherein the cylinder has a periphery with a plurality of apertures disposed about the periphery. The viscous slurry is then passed through the apertures of the cylinder onto a moving conveyor beneath the cylinder to form droplets of such viscous slurry. Such droplets of the viscous slurry cool down to below the glass transition temperature of the PEG material on the moving conveyor, thereby forming a plurality of pastilles having a hemispherical or compressed hemispherical shape (depending on the viscosity of the slurry). The process can be implemented using any of the apparatuses disclosed herein.

In order to control the particle size distribution of water-soluble or water-dispersible filler particles added into the molten PEG to reduce compositional variations in the perfume particles so form, the present disclosure can either select filler particles already having the desired particle size distribution as mentioned hereinabove, or treat filler particles (e.g., through grinding and sieving) to effectuate the desired particle size distribution.

For example, larger alkaline earth metal inorganic salt filler particles can be ground and/or sieved to provide filler particles of smaller particle sizes. The following sieves can be readily used for such purpose:
Sieve # standard Tyler mesh 100 (having a mesh size of 150 microns)
Sieve # standard Tyler mesh 115 (having a mesh size of 125 microns)
Sieve # standard Tyler mesh 150 (having a mesh size of 106 microns)
Sieve # standard Tyler mesh 170 (having a mesh size of 90 microns)
Sieve # standard Tyler mesh 200 (having a mesh size of 75 microns)

Further, smaller inorganic salt filler particles can be sieved out, to provide the desired particle size distribution. The following sieves can be readily used for such purpose:
Sieve # standard Tyler mesh 325 (having a mesh size of 45 microns)
Sieve # standard Tyler mesh 400 (having a mesh size of 38 microns)
Sieve # standard Tyler mesh 625 (having a mesh size of 20 microns)
Sieve # standard Tyler mesh 800 (having a mesh size of 15 microns)
Sieve # standard Tyler mesh 1250 (having a mesh size of 10 microns)
Sieve # standard Tyler mesh 2500 (having a mesh size of 5 microns)

For example, a raw material containing inorganic salt filler particles can be sieved, either with or without being ground first, by a sieve, i.e., Sieve # standard Tyler mesh 100 having a mesh size of 150 microns. Corresponding, the filler particles passing through this first sieve will all have a particle size of no more than about 150 microns. Alternatively, the filler particle raw material can be sieved by Sieve # standard Tyler mesh 115 having a mesh size of 125 microns, so that the filler particles passing through this sieve will all have a particle size of no more than about 125 microns. Alternatively, the filler particle raw material can be sieved by Sieve # standard Tyler mesh 150 having a mesh size of 106 microns, so that the filler particles passing through this sieve will all have a particle size of no more than about 106 microns.

Further, the filler particle raw material can further be sieved by Sieve # standard Tyler mesh 2500 having a mesh size of 5 microns. Because all particles passing through this sieve will have a particle size of no more than about 5 microns, the passing particles can be removed, and the non-passing particles can be retained, to ensure that the filler particles used have a predominant particle size of at least 5 microns. Similarly, the filler particle raw material can further be sieved by Sieve # standard Tyler mesh 1250 having a mesh size of 10 microns, and the passing particles can be removed to ensure that the retained particles (i.e., non-passing particles) have a predominant particle size of at least 10 microns.

### Packaged Composition

A unit dose of the perfume-containing particles made by the method of the present disclosure, or a plurality of such unit doses may be contained in a package, to form a packaged composition. The package may be a bottle, bag, or other container. In one embodiment, the package is a bottle, preferably a PET bottle comprising a translucent portion to showcase the perfume-containing particles to a viewing consumer. In one embodiment, the package comprises a single unit dose (e.g., trial size sachet), or multiple unit doses (e.g., from about 15 unit doses to about 30 unit doses).

### Dosing

A plurality of perfume-containing particles may collectively comprise a unit dose for dosing to a laundry washing machine or laundry was basin. A single unit dose of the pastilles may comprise from about 13 g to about 27 g, alternatively from about 14 g to about 20 g, alternatively from about 15 g to about 19 g, alternatively from about 16 g to about 18 g, alternatively combinations thereof.

The aforementioned package may comprise a dosing means for dispensing the perfume-containing particles from a package to a laundry washing machine (or laundry wash basin in hand washing applications). The user may use the dosing means to meter the recommended unit dose amount or simply use the dosing means to meter the perfume-containing particles according to the user's own scent preference. Examples of a dosing means may be a dispensing cap, dome, or the like, that is functionally attached to the package. The dosing means can be releasably detachable from the package and re-attachable to the package, such as for example, a cup mountable on the package. The dosing means may be tethered (e.g., by hinge or string) to the rest of the package (or alternatively un-tethered). The dosing means may have one or more demarcations (e.g., fill-line) to indicate a recommend unit dose amount. The packaging may include instructions instructing the user to open the removable opening of the package, and dispense (e.g., pour) the perfume-containing particles contained in the package into the dosing means. Thereafter, the user may be instructed to dose the perfume-containing particles in the dosing means to a laundry washing machine or laundry wash basin. The perfume-containing particles of the present disclosure may be used to add freshness to laundry. The package including the dosing means may be made of plastic.

In one embodiment, the perfume-containing particles of the present disclosure can be administered to a laundry machine as used during the “wash cycle” of the washing machine (but a “rinse cycle” may also be used). In another embodiment, the perfume-containing particles of the present disclosure are administered in a laundry wash basin-during washing and/or rinsing laundry. In a laundry hand rinsing application, the perfume-containing particles may further comprise an “antifoam agent” such as those available from Wacker.

### EXAMPLES

### Example 1: Inventive Perfume-Containing Beads

Inventive Examples 1 to 7 of the perfume-containing beads samples are made by the following method.

First, a PEG8000 raw material is heated in an oven at 75° C. overnight to form a molten PEG slurry.

Secondly, suitable amounts of the molten PEG slurry, different level of inorganic salt filler particle (magnesium sulfate, magnesium chloride, respectively) having different particle size distribution, perfume microcapsules, and free perfumes are measured and mixed to form respective perfume-containing compositions, with specific compositional breakdowns as indicated by the Table 1 below. The mixture is hand-mixed for about 10 minutes to form a viscous and homogenous slurry (this can also be done with a motor-driven agitator), while the beaker is placed on a heater to maintain the mixture at a temperature of about 75° C.

The viscous slurry is then poured into molds containing bead-shape cavities at about 30 seconds after the mixing step is completed. The viscous slurry cools down to ambient temperature in molds, thereby forming solidified bead-shaped perfume-containing particles.

TABLE 1
Inventive examples and comparative examples of perfume-containing particles

| | | | | | | | | Comparative | |
|---|---|---|---|---|---|---|---|---|---|
| | Inventive Examples | | | | | | | Examples | |
| Wt % | 1 | 2 | 3 | 4 | 5 | 6 | 7 | A | B |
| PEG8000^{~} | 57% | 47% | 57% | 47% | 57% | 72% | 72% | 88% | 77% |
| Magnesium | 20% | 30% | | — | — | 5% | — | — | — |
| Sulfate | | | | | | | | | |
| (particle | | | | | | | | | |
| size | | | | | | | | | |
| <150 um*) | | | | | | | | | |
| Magnesium | — | — | 20% | 30% | — | — | 5% | — | — |
| Sulfate | | | | | | | | | |
| (particle | | | | | | | | | |
| size | | | | | | | | | |
| 425 um | | | | | | | | | |
| ~600 um^{#}) | | | | | | | | | |
| Magnesium | — | — | — | — | 20% | — | — | — | — |
| chloride | | | | | | | | | |
| (particle | | | | | | | | | |
| size | | | | | | | | | |
| <150 um^{##}) | | | | | | | | | |
| perfume | 8.4% | 8.4% | 8.4% | 8.4% | 8.4% | 8.4% | 8.4% | 8.4% | 8.4% |
| PMC | 14.4% | 14.4% | 14.4% | 14.4% | 14.4% | 14.4% | 14.4% | 3% | 14.4% |
| Other | balance | balance | balance | balance | balance | balance | balance | balance | balance |
| ingredients | | | | | | | | | |
| (colorants, | | | | | | | | | |
| etc) | | | | | | | | | |
| Total | 100% | 100% | 100% | 100% | 100% | 100% | 100% | 100% | 100% |

^{~}PEG8000 commercially available from BASF
*weight average particle size D[4,3] = 62 microns
^{#}weight average particle size D[4,3] = 498 microns
^{##}weight average particle size D[4,3] = 60 microns

Filler material (magnesium sulfate, magnesium chloride in the Examples in Table 1) in the perfume-containing particles are ground and/or sieved through Sieve # standard Tyler mesh as described hereinabove to obtain filler material having a desired mesh size. A weight average particle size can be measured.

Comparative Examples A and B are made by similar method, except for comparative Example A contains low level of PMC and nil inorganic salt, while Comparative Example B contains high level of PMC with nil inorganic salt.

### Example 2: Density of Inventive Examples and Comparative Example

Density is measured by a method shown as below tested 3 times repeatedly. The density of the inventive and comparative examples is listed in Table 2 below.

1. For each measurement, collect 5 beads from a sample.

2. Handle the beads gently as to not damage the bead (causing dents, fines, etc) which could lead to inaccurate results.

3. Ensure enough ethanol (or Hexane for beads with density <500g/L) is in beaker so that the beads, after being placed into upper cup of the universal basket, will be covered with at least 10 mm of liquid after immersion.

4. Suspend the universal basket from the bracket. Ensure that no air bubbles adhere to the immersed part of the holder.

5. Close the draft shield doors and tare balance to read exactly zero.

6. Place 5 beads in upper cup of the universal basket. Record the weight displayed by the balance. This is weight A.

7. Remove the 5 beads in the upper cup of the universal basket with tweezers, being careful to handle the beads gently as to not damage the bead.

8. Close the draft shield doors and tare balance to read exactly zero.

9. Place the same 5 beads in the lower cup of the universal basket. Ensure that no air bubbles adhere to the immersed part of the holder.

10. Wait until the balance has reached stability and record the displayed weight. This is weight B.

11. Determine the density of the sample.

$${ρ}_{B} = \frac{A}{A - B} ( {ρ}_{0} - {ρ}_{L} ) + {ρ}_{L}$$

$${ρ}_{B} = Bead Density$$

$${ρ}_{0} = Density of liquid$$

$${ρ}_{L} = Density of air ( 0.0012 g / {cm}^{3} )$$

TABLE 2
density of Inventive Examples and Comparative Example

| | Inventive | Inventive | Inventive | Inventive | Inventive | Comparative | Comparative |
|---|---|---|---|---|---|---|---|
| | Example 1 | Example 2 | Example 3 | Example 4 | Example 5 | Example A | Example B |
| Density | 1.20 | 1.26 | 1.14 | 1.25 | 1.20 | 1.11 | 1.09 |
| (g/cm³) | | | | | | | |

### Example 3: Hardness Test of the Inventive Examples and Comparative Examples

Hardness of the Inventive Examples and Comparative Examples are tested using Instron compression machine (Model 3369 Table Mounted Materials Testing System, Capacity 50 kN from Instron) with below test method.
1. After production, store beads in closed container and place in 22-25 degC, 30-50 RH % environment for at least 24 hr.
2. Place one bead on the bottom measuring plate with bottom flat side face down. Balance the load.
3. In Instron compression mode, set extension as control mode and compression speed as 8 mm/min. Start the procedure.
4. After the top plate getting contact with the bead, when detect a force value drop on the result graph, treat the load drop point as one effective hardness data and stop the machine.

TABLE 3
Hardness of Inventive Examples and Comparative Example

| | Comparative | Comparative | Inventive | Inventive | Inventive | Inventive | Inventive |
|---|---|---|---|---|---|---|---|
| Hardness | Example A | Example B | Example 1 | Example 2 | Example 3 | Example 4 | Example 5 |
| Compared to | 100% | −57% | +9% | +22% | −40% | +4% | +181% |
| Comp Ex. A | | | | | | | |

Table 3 shows the comparison of hardness of the Inventive Examples to the Comparative Example 1. It can be seen from data shown in Table 3 that when PMC level is increased (from 3% in Comparative Example A to 14.4% in Comparative Example B), the hardness is getting significantly decreased (−57%). However, interestingly, Inventive Examples 1 to 5 where same high level PMC is contained and magnesium sulfate or magnesium chloride inorganic salts are added, show significantly increased hardness compared to Comparative Example B. Further, Inventive Example 1 containing magnesium sulfate of particle size less than 150 microns shows higher hardness than Inventive Example 3 in which the magnesium sulfate having particle size between 425 microns to 600 microns.

### Example 4: Dissolution/Solubility of the Inventive Examples and Comparative Examples

Dissolution of the Inventive Examples and Comparative Examples are tested by below.

1. Select 5 regular Scent beads samples and record the weight x;

2. Take 500 ml of water in a beaker, place a rotor in the beaker, adjust the mixer so that the water in the beaker forms a vortex and ensure that the height of the vortex is half of the height of the water;

3. Take pictures at intervals and adjust the height of the camera, then pour the beads sample into the beaker and record the dissolution time of the beads with the camera. Set dissolution time as y.

4. To better compare between different formula, standardize measured beads weight to 0.19 g, which means the dissolution time=y*0.19/x.

TABLE 4
Dissolution of Inventive Examples and Comparative Example

| | Comparative | Comparative | Inventive | Inventive | Inventive | Inventive | Inventive | Inventive | Inventive |
|---|---|---|---|---|---|---|---|---|---|
| Dissolution | Example A | Example B | Example 1 | Example 2 | Example 3 | Example 4 | Example 5 | Example 6 | Example 7 |
| Time (s) | 445 | 607 | 247 | 196 | 378 | 352 | 408 | 464 | 520 |
| Ratio | 100% | −36% | +44% | +56% | +15% | +21% | +8% | −4% | −17% |
| Compared | | | | | | | | | |
| to Comp | | | | | | | | | |
| Ex. A | | | | | | | | | |

Ratio = (Dissolution time of Comparative A − dissolution time of Inventive)/Dissolution time of Comparative A

It can be seen from Table 4 that Inventive examples containing desired inorganic salt with desired particle size have shorter dissolution than the comparative examples A and B contains PEG and perfumes with nil inorganic salt.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any composition or method disclosed or claimed herein or that it alone, or in any combination with any other reference or references, teaches, suggests or discloses any such composition or method. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A composition comprising a plurality of perfume-containing particles, wherein each of said perfume-containing particles comprises:
a perfume ingredient;
polyethylene glycol; and
an alkaline earth metal inorganic salt which is selected from the group consisting of magnesium sulfate, magnesium chloride, and the combination thereof,
wherein each of said perfume-containing particles has a mass of from 1 mg to 1 g and a maximum dimension of from 3 mm to 10 mm.

2. The composition of claim 1, wherein each of said particles has a density more than 1 g/cm³.

3. The composition of claim 1, wherein the perfume ingredient comprises an encapsulated perfume.

4. The composition of claim 1, wherein the perfume ingredient comprises an encapsulated perfume present in friable perfume microcapsules, and the friable perfume microcapsules are present in an amount ranging from more than 2% to 30% by weight of each perfume-containing particle.

5. The composition of claim 1, wherein the perfume ingredient comprises one or more free perfumes, which are present in an amount ranging from 0.1% to 20% by weight of each perfume-containing particle.

6. The composition of claim 1, wherein the perfume ingredient comprises one or more free perfumes, which are present in an amount ranging from 0.5% to 15% by weight of each perfume-containing particle.

7. The composition of claim 1, wherein the polyethylene glycol has a weight average molecular weight (Mw) from 2,000 to 30,000 Daltons; wherein the polyethylene glycol is present in each perfume-containing particle in an amount ranging from 5% to 90% by weight of each perfume-containing particle.

8. The composition of claim 1, wherein the polyethylene glycol has a weight average molecular weight (Mw) from 3,000 to 20,000 Daltons; wherein the polyethylene glycol is present in each perfume-containing particle in an amount ranging from 40% to 85% by weight of each perfume-containing particle.

9. The composition of claim 1, wherein each of said perfume-containing particles comprises from 1% to 40% of the alkaline earth metal inorganic salt, by weight of each perfume-containing particle.

10. The composition of claim 1, wherein each of said perfume-containing particles comprises from 2% to 35% of the alkaline earth metal inorganic salt, by weight of each perfume-containing particle.

11. The composition of claim 1, wherein from 80 wt % to 100 wt % of the alkaline earth metal inorganic salt are particles characterized by a particle size of from 50 microns to 600 microns.

12. The composition of claim 1, wherein each of the perfume-containing particles further comprises one or more other ingredients selected from the group consisting of colorants, solvents, and combinations thereof, and wherein said one or more other ingredients are present in an amount ranging from 0.01% to 10% by weight of each perfume-containing particle.

13. The composition of claim 1, wherein each of said particles has a hemispherical shape, a compressed hemispherical shape, or a hemi-ellipsoidal shape.

14. The composition of claim 1, wherein each of said particles has a mass from 5 mg to 1 g.

15. The composition of claim 1, wherein each of said particles has a maximum dimension of from 4 mm to 9 mm.

16. The composition of claim 1, wherein each of said particles has a mass from 10 mg to 500 mg and a maximum dimension of from 4 mm to 9 mm.

17. The composition of claim 1, wherein:
the perfume ingredient comprises an encapsulated perfume present in friable perfume microcapsules, and the friable perfume microcapsules are present in an amount ranging from more than 2% to 30% by weight of each perfume-containing particle;
the perfume ingredient comprises one or more free perfumes, which are present in an amount ranging from 0.1% to 20% by weight of each perfume-containing particle;
wherein the polyethylene glycol has a weight average molecular weight (Mw) from 2,000 to 30,000 Daltons; wherein the polyethylene glycol is present in each perfume-containing particle in an amount ranging from 5% to 90% by weight of each perfume-containing particle
wherein each of said perfume-containing particles comprises from 1% to 40% of the alkaline earth metal inorganic salt, by weight of each perfume-containing particle; and
wherein each of said particles has a mass from 10 mg to 500 mg and a maximum dimension of from 4 mm to 9 mm.

18. A method of making perfume-containing particles, comprising the steps of:
a) forming a viscous slurry by mixing a perfume ingredient, molten polyethylene glycol, inorganic salt filler particles and optionally one or more other ingredients, wherein said inorganic salt filler particles can pass through a sieve characterized by a mesh size of 600 um; and
b) forming perfume-containing particles from the viscous slurry, wherein each of the perfume-containing particles so formed has a mass of from 1 mg to 1 g and a maximum dimension of from 3 mm to 10 mm;
wherein said inorganic salt filler particles comprise a filler material selected from the group consisting of magnesium sulfate, magnesium chloride, and the combination thereof.

19. The method according to claim 18, wherein said inorganic salt filler particles can pass through a sieve characterized by a mesh size of 400 um.

20. The method according to claim 18, wherein said inorganic salt filler particles can pass through a sieve characterized by a mesh size of 150 um
